(19) United States
(12) Patent Application Publication
(10) Pub. No.: US 2007/0014960 A1
(43) Pub. Date: Jan. 18, 2007

(54) Fire retardant binding tape for mattresses

(75) Inventors: Brian K. Emanuel, Eureka, MO (US); Terry L. Garris, Imperial, MO (US)

Correspondence Address: DOUGHERTY CLEMENTS, 1901 ROXBOROUGH ROAD, SUITE 300, CHARLOTTE, NC, 28211, US

(73) Assignee: Western Nonwovens, Inc.

(21) Appl. No.: 11/183,583

(22) Filed: Jul. 18, 2005

(51) Int. Cl. B32B 27/04; B32B 33/00; B32B 5/02

(52) U.S. Cl. 428/41.8; 442/126; 442/141; 442/149; 442/152; 442/153; 442/154; 442/395; 442/398; 428/219; 428/220; 428/343; 428/352; 428/354; 428/920; 428/921

(57) ABSTRACT

The present invention relates to a fire retardant binding tape. The binding tape is employed to affix the butt splice joint (or overlapping joint) between rolls of fire retardant material, where one roll ends and another begins. Should the binder tape be subject to elevated temperatures, it will shrink toward the joint seam, thus strengthening the seam, and form a char that minimizes heat input to the flammable materials (foam) located beneath the fire retardant barrier material. The nonwoven binding tape has fire retardant cellulosic fibers, a low melt binder, and an adhesive on one side used to affix the binding tape to the edge butted pieces of a flame retardant barrier material. Instead of the low melt binder, the fibers may be mechanically secured. Optionally a carrier film layer may be used to make the tape more rigid.

### BACKGROUND OF THE INVENTION

1) Field of the Invention

A good mattress meeting the safety standards of California has a fire retardant material between the foam layer and the cover ticking. The fire retardant material minimizes the propensity to burn when exposed to an open flame. The fire retardant material is typically a nonwoven material on a roll wider than the mattress. The present invention relates to a fire retardant binding tape. The binding tape of the present invention is employed to splice the joint between rolls of fire retardant material, where one roll ends and another begins. Although butt splicing is preferred, overlap splicing is within the scope of the present invention.

2) Prior Art

Mattress fires cause deaths of approximately 500 people each year. The State of California has enacted regulations requiring mattresses to be sold that meet certain performance requirements. Those performance requirements are spelled out in California Test Bulletin 129 for hotel mattresses and California Test Bulletin 603 for residential mattresses.

Generally, the California Technical Bulletin 129 (for mattresses used in public) states that the mattress must char but not burn through for a minimum of 3 minutes based on certain conditions such as the position of the flame, temperature of the flame, the source of the flame being used, etc. Moreover, after one hour (57 minutes after the flame source has been extinguished) of burning, the test is terminated and certain conditions must be met as more fully set forth herein.

California Technical Bulletin 603 (for residential mattresses) states that a specific pair of propane test burners is placed on the top panel and border of the mattress/foundation set. The burners are ignited and left to burn for 70 seconds (top) and 50 seconds (border). After both burners are out, the mattress continues burning until either all combustion is ceased, or the development of the fire is such size as to require suspension for the safety of the facility. The Total Heat Release during the first 10 minutes after burner ignition cannot exceed 25 MJ, and after 30 mins., the total maximum rate of heat release must be less than 200 kW.

Foam employed in the mattress burns and can quickly engulf the mattress in flames. The above safety standards seek to place a fire retardant material between the foam and a person on or near the mattress. FR mattresses are made with a fire retardant material, typically a nonwoven, which is placed over and around foam employed in the mattress. Covering the fire retardant material of the mattress is typically a flat top component, a flat bottom component, and a long sidewall component that wraps around the entire mattress edge periphery. These exterior components are also referred to as the ticking. The fire retardant material is typically wound on a roll that is wider than the mattress being constructed. When one roll of the fire retardant material is depleted, the next roll would be butted edgewise to the depleted roll. However, when a mattress is constructed with an edge butt of the fire retardant material, that section of material is typical discarded because it does not provide adequate protection. Sometimes, depending on the method of construction, the entire mattress panel is discarded, because all components of a mattress are synchronized and it is not possible to stop the synchronization process without serious consequences—i.e., shutting down the entire line.

There is a need in the industry to reduce the scrap-discarded materials used to construct a mattress when the roll of fire retardant material runs out. There is also a need to keep the production line for making mattresses continuous in operation by reducing waste.

### SUMMARY OF THE INVENTION

To satisfy the aims and objects of the industry and to obtain the advantages of reducing the scrap discarded materials, the present invention pertains to a binding tape that is used to adhere the edge butts of the fire retardant material, where one roll ends and another begins. The binding tape includes nonwoven fire retardant (FR) fibers bound together with a low melt binder, an adhesive layer, and optionally a carrier film layer. Should it be subject to elevated temperatures or flame, it will shrink toward the seam formed by the end of one roll and beginning of the current roll of flame retardant barrier material, thus strengthening the seam, and form a char that minimizes heat input to the flammable materials (foam) located beneath the flame retardant barrier. Although a low melt binder is preferred, the FR fibers may be mechanically bound together instead of employing the low melt binder.

In the broadest sense, the present invention comprises a binding tape having nonwoven fire retardant cellulosic fibers, a low melt binder, and an adhesive on one side used to affix the binding tape to pieces of a flame retardant barrier, and optionally a release sheet and optionally a carrier film layer.

### BRIEF DESCRIPTION OF THE DRAWINGS

The drawings are only to be used as an aid in understanding the invention. They are not meant to limit the scope of the invention beyond that set forth by the claims.

FIG. 1 is a schematic cross section of the FR binding tape without a carrier film layer.

FIG. 2 is a schematic cross section of the FR binder tape applied to a butt edge of two pieces of flame retardant material.

FIG. 3 is a schematic cross section of an alternate embodiment of the FR binding tape with a carrier film.

### DESCRIPTION OF THE PREFERRED EMBODIMENTS

The binding tape comprises: nonwoven fire retardant cellulosic fibers, structurally bound together mechanically or with a low melt binder to structural lock the fibers, and an adhesive. The tape has a basis weight of between about 0.2 to about 2.5 ounces per square foot. Basis weights below this amount do not provide adequate fire retardancy protection especially for mattresses that must pass the California TB 129 and 603 tests. Basis weights above this range have two problems, namely: 1) they are so thick that they affect the aesthetics and/or quality of the sleep surface, and 2) for the increase in cost of the thicker tape, there is no corresponding additional increase in fire retardancy.

Cellulosic fibers include rayon, cotton, hemp, jute, cellulose acetate, etc. The cellulosic fibers are either synthetic fibers (rayon, cellulose acetate, etc) or natural fibers (cotton, hemp, jute, etc) that have flame retardancy. The synthetic fibers can be typical fibers that are post-treated or fibers that are inherently flame retardant. By inherently flame retardant rayon fibers, we mean that the synthetic fiber is made with the fire retardancy material uniformly incorporated into the structure or raw materials prior to formation of the fiber (incorporated into the resin). One inherent rayon fiber has silica incorporated therein, and is sold under the trademark Visil® by Sateri Co. of Finland. Another inherent rayon fiber is produced by Lenzing Fibers and marketed as Lenzing FR. Synthetic or natural fibers that are not inherently flame retardant can be post-treated with a flame or fire retardant coating. By post-treated fibers, we mean that the fiber is formed and then post-treated with a flame retardant chemical. The post-treated cellulosic fibers are treated with a phosphorous based fire retardant compound. Halogenated fire retardant coatings generally emit toxic gas when subject to heat and are therefore unacceptable. The fire retardant cellulosic fibers comprise between about 30 wt % to about 85 wt-% of said tape.

The low melt binder is either bicomponent fibers or fibers having a low melting point. When the binder is bicomponent fiber, it contains a low melt portion and a high melt portion. Consequently, the bicomponent fiber may be either the side-by-side type where the low melt component is adjacent to the high melt component, or the sheath-core type wherein the high melt component is the core and low melt component forms the sheath. Such bicomponent fibers are well known to those skilled in the art and may be based upon polyolefin/polyester (e.g., polypropylene/polyethylene terephthalate), copolyester/polyester (e.g., polyethylene terephthalate, isophthalate/polyethylene terephthalate), polyester/polyester (e.g., polyethylene isophthalate/polyethylene terephthalate), polyolefin/polyolefin (e.g., polypropylene/polyethylene), wherein the naming convention is the low melt component followed by the high melt component. In those types wherein it is polyester/polyester, or polyolefin/polyolefin the high melt component has at least 5 and preferably 8° F. higher melting temperature than the melting temperature of the low melt component. Suitable bicomponent fibers are preferably a 50/50 low melt to high melt portion. But the present invention also contemplates a broader range of the low melt component to the high melt component of 20:80 to 80:20 for the bicomponent fiber.

When the binder is a low melt polymer fiber, those fibers mentioned above with respect to the low melt component of the bicomponent fiber are also suitable low melt polymer fibers. In other words, the low melt polymer fiber (low melt compared to the other fibers in the non-woven) may be copolyester or polyolefin. Upon heating, the low melt polymer binder fibers melt and the molten low melt liquid coalesces at the contact points of the cellulosic and/or other fibers present. Upon cooling, the low melt solidifies and forms a rigid non-woven structure with the fibers present.

The low melt binder comprises from about 12 wt. % to about 30 wt. % of said tape. Employing less low melt binder does not adequately bond the nonwoven. Employing more than about 30 wt. % does not provide a corresponding increase in bonding the nonwoven.

The nonwoven cellulosic fibers can also be bound by mechanical means such as needle punching or hydroentanglement, both being well known to those skilled in the art. It may be necessary to dry the fibers if hydroentanglement is employed to structurally lock the nonwoven fibers into a unitary batt.

The adhesive may be coated on the nonwoven fibers or on an optional carrier film. Alternatively, a double-sided adhesive tape well known to those skilled in the art may be used. The adhesive is either water based, solvent based, or rubber based. The water based or solvent based adhesive typically contains an acrylic component. The rubber based adhesive contains styrene butadiene rubber (SBR), polyisoprene, polychloroprene, acrylonitrilebutadiene, ethylene-propylene diene monomer (EPDM), or a combination of two or more of these. As is typically known, the adhesive is applied from about 0.01 ounces per square foot to about 1 ounce per square foot. This corresponds to about 0.5 to about 5 mil thickness of adhesive. To keep the adhesive from bonding to everything it contacts, before it is employed in the present invention, a release sheet may be employed on the side opposite the nonwoven fibers, or carrier film as will be shown in the drawings later. The release sheet may be kraft paper or wax paper, or synthetic plastic film with or without a silicone coating.

An optional carrier film layer for the adhesive is either paper or a synthetic plastic film. Suitable synthetic plastic film may be either polyester film or polyolefin film. Other suitable plastic films may also be employed. Suitable paper films may be kraft paper (without any release coating), synthetic paper, and the like. Preferably the carrier film is plastic film. Also within the scope of the invention is applying the adhesive directly on the fire retardant barrier layers. That is applying the adhesive at the seam of the two fire retardant materials. While this is within the scope of the invention it is not as desirable as using a carrier film, because it would require an applicator mechanism such as spraying. Introducing such a mechanism to be used only when a seam appears, is costly and inefficient.

In addition to the fiber mention above, the nonwoven can also include additional fire retardant fibers, or non fire retardant synthetic or natural fibers, or both. Suitable fire retardant fibers comprise coated polyester, coated polyolefin, modacrylic, wool or silk fibers, and coated natural cellulosic and non-cellulosic fibers. Wool and silk fiber are inherent FR fibers. Suitable non fire retardant fibers, which can comprise up to about 15 wt. % of the total wt of the fibers are polyester, rayon, polyolefin, cotton, hemp, kenaf, alpaca, angora, or cashmere fibers, none of which have been post-treated.

The nonwoven batt may be constructed as follows. The various combination of fibers employed in the present invention can be weighed and then dry laid/air laid onto a moving conveyor belt, for example. The size or thickness of a nonwoven batt is generally measured in terms of ounces per square yard. The speed of the conveyor belt for example can determine or provide the desired batt weight. If a thick batt is required, then the conveyor belt moves slower than for a thin batt. The weight % of the total fibers in the batt is 100%. If the post-treated fibers are not purchased with the FR coating applied, then the fibers should be coated with an FR coating before the making of the nonwoven. Of course it is within the scope of the present invention to form a nonwoven of rayon fibers and low melt fibers, for example and then spray coat the nonwoven with an FR coating. The amount of FR coating applied in either application is generally in the range of 6 to 25 wt. % of the fiber to be coated (6 to 25 wt. % add-on).

The FR coating for the post treated fibers contains one or more of phosphorus, phosphorus compound(s), red phosphorus, esters of phosphorus, and phosphorus complexes. FR coatings that contain halogen based compounds emit halogen gasses upon heating and are unacceptable. The typical FR coating is clear or translucent latex and is applied by spraying or dipping (saturation). Other non-clear FR coatings are also known and are employed where color is not important. A suitable commercially available FR coating is sold under the trade name Guardex/FR, or FFR that is produced by Glotex Chemicals in Spartanburg, S.C. While there are several different varieties of Guardex and Glotex FR coatings, those skilled in the art can pick and choose among them to find that which is most compatible, taking into account such things as cost, appearance, smell, and the affect it may have on other fibers in the nonwoven batt (does it make the other fibers rough, or have a soft hand, or discolor the other fibers, etc.). FR coating may be applied to specific fibers in a range from about 6 to 25 weight % of the weight of the specific fibers or the nonwoven article. Although the FR resin may be in liquid form, the amount of add-on is always on a dry wt. basis. The FR resin could be applied to natural or synthetic fibers before they are dry laid/air laid onto a conveyor belt. It is also within the scope of the present invention to purchase the fiber already coated with the desired FR coating, and merely blend them into the nonwoven fabric. Non-resin coatings like metallic coating are not suitable for the present invention, because they tend to flake-off after continuous use of the product.

The fibers on the conveyor belt are then either mechanically bonded or bonded with a low melt binder. If they are needlepunch, the conveyor belt proceeds to a needlepunch machine and the fibers are bonded into a batt having structural integrity. If a low melt binder is used, the nonwoven proceeds to an oven to heat and melt the low melt resin in the binder. Then the conveyor travels to a cooling zone where the low melt resin resolidifies, thus bonding the fibers into a batt.

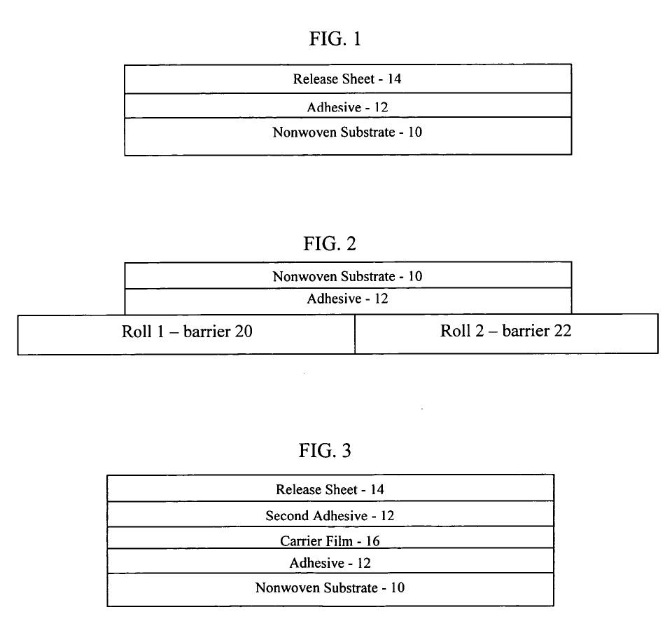

Construction of the FR binder tape, illustrated in FIGS. 1 and 2, is as follow: the FR non-woven batt (or substrate) 10, made with the low melt binder and cellulosic FR fibers, is secured to one side of the adhesive 12. The adhesive may be applied to the batt 10, or more preferably, the adhesive is in the form of double sided tape, where one side is applied to the batt 10. The opposite side of the adhesive binds the tape to two edge butted (or overlapped) pieces 20, 22 of fire retardant material. The adhesive side of the tape may have a protective release sheet 14, a throw-away strip of film or paper, for example, that keeps the adhesive from sticking to everything, before it is employed in the mattress construction.

To provide the FR binder tape with more rigidity, it may be desirable to employ a carrier film as illustrated in FIG. 3. During its construction, an FR nonwoven batt (or substrate) 10 is applied to an adhesive 12 as explained with respect to FIG. 1. To the other side of the adhesive a carrier film 16 is applied, and a second adhesive 12 (preferable another strip of double sided tape) is secured to the other side of the carrier film, such that the carrier film 16 has an adhesive 12, 12 secured to both sides. To the second adhesive may be applied a release sheet 14 to keep the tape from adhering to anything before it is used to secure the two pieces of fire retardant material 20, 22.

A mattress may be constructed using the present invention by taking a stock of foam, covering the foam in a fire retardant material having one or more pieces, securing or affixing the pieces to one another with an FR binding tape having nonwoven FR cellulosic fibers and an adhesive layer. Then the covered foam is then further covered with ticking to form a mattress. The pieces of fire retardant material may be butt edged or overlapped. The FR binding tape may include a carrier film to make the tape more rigid, as described above.

### General Test Procedures

The criterion for compliance for TB 603 is as follows;

Less than 25 MJ of total heat release at 10 minutes after burner ignition

Less than 200 kW of heat release rate at 30 minutes after burner ignition

Two burners are used to initiate the test. One on the panel, flame duration of 70 seconds, and one on the border with a flame duration of 50 seconds. Both are lit simultaneously.

Western Nonwovens, Inc. produced two sets of mattresses and box springs to evaluate the performance of binder tape in full-scale burns against TB603 compliance criteria. The tape consisted of a 0.44 ounce per square foot blend of 75% flame retardant and 25% low melt polyester fiber). The adhesive was carrier-less and water based. Both mattress sets were twin sized, tight tops and two-sided with high profile borders. Both mattresses contained a 0.8-ounce per square foot flame retardant barrier fabric, directly beneath the mattress ticking. The flame retardant barrier fabric contained two splices in the top panel. One splice approximately 8 inches, and the other approximately 22 inches from the leading edge of the mattress. The sidewall component of the mattresses contained three splices. One splice exactly in the center, with one equidistant between the center splice and each adjacent corner. The splice in the top panel, eight inches from the front edge, and the splice in the center of the sidewall were located such that the flame from the burners impinged directly onto the spliced areas. This was considered the most severe evaluation in that in likelihood no mattress would have more than one splice in the top panel and one in the sidewall. In addition, the likelihood of both splices occurring directly at the flame impingement points is very low.

The results are listed in Table 1 below.

TABLE 1

| | 10 Minute Total Heat | 30 Minute Heat Release |
|---|---|---|
| | Release (MJ) | Rate (kW) |
| EsyntialTape Bed 1 | 9 | 25 |
| EsyntialTape Bed 2 | 12 | 29 |

As can be seen from Table 1 above, both beds were TB603 compliant.

Table 2 below lists the various binder tape products that we have constructed and tested on the bench scale apparatus. The “Avg 40-90” temperatures are the average temperatures from forty through ninety seconds sampled in increments of ten seconds. The samples were prepared by taking a 0.8-ounce per square foot flame retardant barrier fabric, comprised of 75% Visil and 25% low melt polyester, and butt-seaming together with various binder tape variants. The various binder tape substrates are listed in the second column. The components and respective percentages of each for each substrate are listed in columns four through seven.

TABLE 2

| Basis | | | | | | | Avg |
|---|---|---|---|---|---|---|---|
| Weight (opsf) | Component 1 | Component 2 | Component 3 | Component 4 | Adhesive Type | Carrier Film | 40-90 |
| 0.22 | 75% Post-Treated Rayon | 25% Low Melt PET | n/a | n/a | Acrylic Water Base | Yes | 361 F. |
| 0.44 | 75% Post-Treated Rayon | 25% Low Melt PET | n/a | n/a | Rubber Base | Yes | 456 F. |
| 0.44 | 75% Post-Treated Rayon | 25% Low Melt PET | n/a | n/a | Acrylic Solvent Base | Yes | 394 F. |
| 0.44 | 75% Post-Treated Rayon | 25% Low Melt PET | n/a | n/a | Acrylic Solvent Base | No | 401 F. |
| 0.44 | 75% Post-Treated Rayon | 25% Low Melt PET | n/a | n/a | Acrylic Water Base | Yes | 328 F. |
| 0.8 | 75% Post-Treated Rayon | 25% Low Melt PET | n/a | n/a | Acrylic Water Base | Yes | 288 F. |
| 2.22 | 75% Post-Treated Rayon | 25% Low Melt PET | n/a | n/a | Acrylic Water Base | Yes | 166 F. |
| 1 | 75% Visil | 25% Low Melt PET | n/a | n/a | Acrylic Water Base | Yes | 165 F. |
| 1 | 40% Post-Treated Rayon | 30% Mod-Acrylic | 15% Low Melt PET | 15% Polyester | Acrylic Water Base | Yes | 237 F. |
| 1 | 40% Post-Treated Rayon | 30% Mod-Acrylic | 15% Low Melt PET | 15% Polyester | Rubber Base | Yes | 261 F. |
| 1.22 | 40% Visil | 30% FR Polyester | 15% Low Melt PET | 15% Polyester | Acrylic Water Base | Yes | 207 F. |
| 1.22 | 40% Visil | 30% FR Polyester | 15% Low Melt PET | 15% Polyester | Rubber Base | Yes | 184 F. |

Thus, it is apparent that there has been provided, in accordance with the invention, an FR binder tape that fully satisfies the objects, aims, and advantages set forth above. While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the invention.

What is claimed is:

1) A binding tape comprising: nonwoven fire retardant cellulosic fibers, a low melt binder, and an adhesive.

2) The binding tape of claim 1, wherein said tape has a basis weight of between about 0.2 to about 2.5 ounces per square foot.

3) The binding tape of claim 1, wherein said fire retardant cellulosic fibers are either inherently flame retardant or post-treated flame retardant.

4) The binding tape of claim 3, wherein said inherent fibers are synthetic fibers and have silica or a phosphorus compound incorporated within the synthetic resin.

5) The binding tape of claim 3, wherein said post-treated flame retardant fibers are treated with a phosphorous-based fire retardant compound.

6) The binding tape of claim 1, wherein said fire retardant cellulosic fibers comprise between about 30 wt. % to about 85 wt. % of said tape.

7) The binding tape of claim 1, wherein said low melt binder is either bicomponent fibers or fibers having a low melting point.

8) The binding tape of claim 7, wherein said low melt binder comprises from about 12 wt. % to about 30 wt. % of said tape.

9) The binding tape of claim 1, wherein said cellulosic fibers can be one or more of rayon, cotton, hemp, juts, and cellulose acetate.

10) The binding tape of claim 1, further including a carrier that is either a polyester or a polyolefin based film.

11) The binding tape of claim 1, wherein said adhesive is either water based, solvent based, or rubber based.

12) The binding tape of claim 11, wherein said water based or said solvent based adhesive contains an acrylic component.

13) The binding tape of claim 11, wherein said rubber based adhesive contains SBR, polyisoprene, polychloroprene, acrylonitrilebutadiene, EPDM, or a combination of two or more of these.

14) The binding tape of claim 1, wherein said adhesive is from about 0.5 mil to about 5.0 mil thick.

15) The binding tape of claim 1, wherein said nonwoven comprises additional fire retardant fibers, or non fire retardant synthetic or natural fibers, or both.

16) The binding tape of claim 15, wherein said additional fire retardant fibers comprise coated polyester, coated polyolefin, modacrylic, wool or silk fibers.

17) The binding tape of claim 15, wherein said non fire retardant fibers comprise polyester, rayon, polyolefin, cotton, hemp, alpaca, angora, or cashmere fibers.

18) A binding tape comprising: nonwoven fire retardant rayon fibers, a low melt binder, and a carrier film coated with an adhesive, wherein said tape has a basis weight of between about 0.2 to about 2.5 ounces per square foot, said fire retardant rayon fibers are either inherent rayon fibers or post-treated cellulosic fibers, said fire retardant cellulosic fibers comprise between about 30 wt. % to about 85 wt. % of said tape, wherein said low melt binder is either bicomponent fibers or fibers having a low melting point, and said low melt binder comprises from about 12 wt. % to about 30 wt. % of said tape.

19) A binding tape comprising: a nonwoven substrate having fire retardant cellulosic fibers, and adhesive and a release sheet, wherein said adhesive is positioned between said fibers and said release sheet.

20) A binding tape comprising: a nonwoven substrate having fire retardant cellulosic fibers, and adhesive layer affixed to said nonwoven fibers, a carrier film secured to said adhesive layer, a second adhesive layer secured to said carrier film, and a release sheet temporarily affixed to said second adhesive.

21) A method of constructing a mattress, comprising: providing a stock of foam, covering said foam in a layer of fire retardant material comprising multiple pieces, securing said multiple pieces of fire retardant material with binding tape, said binding tape having nonwoven flame retardant cellulosic fibers and an adhesive, and providing said covered foam with a ticking.
